(19) United States
(12) Patent Application Publication
(10) Pub. No.: US 2026/0321467 A1
(43) Pub. Date: Oct. 15, 2026

(54) RARE EARTH MAGNET

(71) Applicants: TOYOTA JIDOSHA KABUSHIKI KAISHA, Toyota-shi (JP); NICHIA CORPORATION, Anan-shi (JP)

(72) Inventors: Masaaki ITO, Anjo-shi (JP); Motoki HIRAOKA, Toyota-shi (JP); Masaki HAYASHI, Anan-shi (JP)

(73) Assignees: TOYOTA JIDOSHA KABUSHIKI KAISHA, Toyota-shi (JP); NICHIA CORPORATION, Anan-shi (JP)

(21) Appl. No.: 19/637,606

(22) Filed: Apr. 2, 2026

(30) Foreign Application Priority Data
Apr. 8, 2025 (JP) 2025-063900

(51) Int. Cl. H01F 1/055

(52) U.S. Cl. CPC H01F 1/0557

(57) ABSTRACT

Provided is a rare earth magnet that allows for an improvement in residual magnetization Br. The rare earth magnet of the present disclosure comprises a sintered body of a mixed powder having (comprising) a magnetic powder containing magnetic particles containing Sm, Fe, and N, and a zinc powder containing zinc particles containing at least one of a metallic zinc or a zinc alloy. A standard deviation of areas of Voronoi regions in a Voronoi diagram obtained by Voronoi tessellation using centers of gravity of zinc component phases of the zinc particles as seeds (sites or generators) on a cross-sectional surface of the sintered body is 65 μm² or less.

### CROSS REFERENCE TO RELATED APPLICATIONS

The present application claims priority from Japanese patent application JP 2025-063900 filed on Apr. 8, 2025, the entire content of which is hereby incorporated by reference into this application.

### BACKGROUND

### Description of Related Art

The present disclosure relates to a rare earth magnet, and relates to a rare earth magnet in which a magnetic powder containing magnetic particles containing Sm, Fe, and N is sintered.

### Background Art

Conventionally, as a high-performance rare earth magnet, an SmCo-based rare earth magnet and a NdFeB-based rare earth magnet have been put into practical use. In recent years, a SmFeN-based rare earth magnet containing Sm, Fe, and N has been developed as a rare earth magnet other than these. The SmFeN-based rare earth magnet is produced using an SmFeN-based magnetic powder containing magnetic particles containing Sm, Fe, and N. As the SmFeN-based rare earth magnet, for example, a rare earth magnet including a sintered body in which a mixed powder containing the SmFeN-based magnetic powder and a zinc powder containing a zinc component is pressure-sintered, and the rare earth magnet in which the SmFeN-based magnetic powder is reacted with the zinc component of the zinc powder during pressure sintering the mixed powder to form a modified phase on the surface of the magnetic powder, thereby suppressing demagnetization is known (JP 2023-077289 A). Furthermore, a sintered magnet of the SmFeN-based magnetic powder in a scale shape having (comprising) a relative (bulk) density of 83 volume % or more is known (JP 2013-089813 A).

### SUMMARY

As in the rare earth magnet described in JP 2023-077289 A, as for the rare earth magnet including the sintered body in which a mixed powder containing the SmFeN-based magnetic powder and a zinc powder containing a zinc component is pressure-sintered, a pressure during the pressure sintering is increased in order to attempt densification of the sintered body for the purpose of improving residual magnetization Br. When the pressure during the pressure sintering is increased, however, strain accumulates in the magnetic phase of the sintered body, which may result in failure in achieving an improvement in the residual magnetization Br. Furthermore, during the pressure sintering of the mixed powder, the SmFeN-based magnetic powder fails to sufficiently flow because of large friction between the particles, and therefore, fails to achieve the densification of the sintered body density, which may lead to failure in achieving an improvement in the residual magnetization Br.

The present disclosure provides a rare earth magnet that allows for an improvement in residual magnetization Br.

In order to solve the problem, a rare earth magnet of the present disclosure comprises a sintered body of a mixed powder having (comprising) a magnetic powder containing magnetic particles containing Sm, Fe, and N, and a zinc powder containing zinc particles containing at least one of a metallic zinc or a zinc alloy. A standard deviation of areas of Voronoi regions in a Voronoi diagram obtained by Voronoi tessellation using centers of gravity of zinc component phases as seeds (sites or generators) on a cross-sectional surface of the sintered body is 65 μm² or less.

### Effect

The present disclosure allows for an improvement in residual magnetization Br of a rare earth magnet.

### BRIEF DESCRIPTION OF THE DRAWINGS

FIGS. 1A to 1D are schematic process drawings illustrating a method for producing a rare earth magnet according to a first embodiment;

FIGS. 2A and 2B are schematic process drawings illustrating the method for producing the rare earth magnet according to the first embodiment;

FIG. 3 is SEM images of zinc powders in Example 1 and Comparative Example 1;

FIGS. 4A-1 and 4B-1 are respective element mapping images of zinc on cross-sectional surfaces of sintered bodies of rare earth magnets in Example 1 and Comparative Example 1;

FIGS. 4A-2 and 4B-2 are respective Voronoi diagrams of zinc component phases of on the cross-sectional surfaces of the sintered bodies of the rare earth magnets in Example 1 and Comparative Example 1; and

FIG. 4C is standard deviations [μm²] of areas of Voronoi regions in the Voronoi diagrams of the zinc component phases on the cross-sectional surfaces of the sintered bodies of the rare earth magnets in Example 1 and Comparative Example 1.

### DETAILED DESCRIPTION OF THE EMBODIMENTS

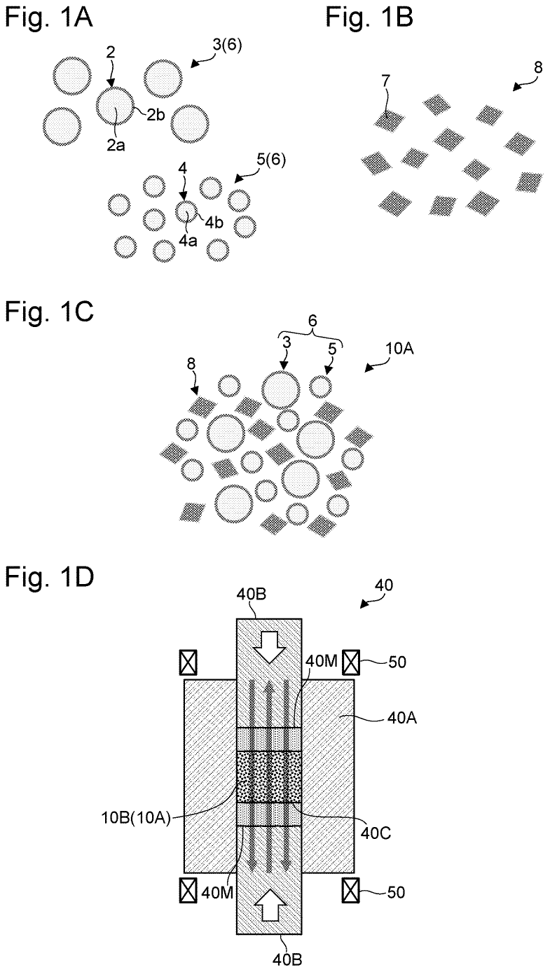

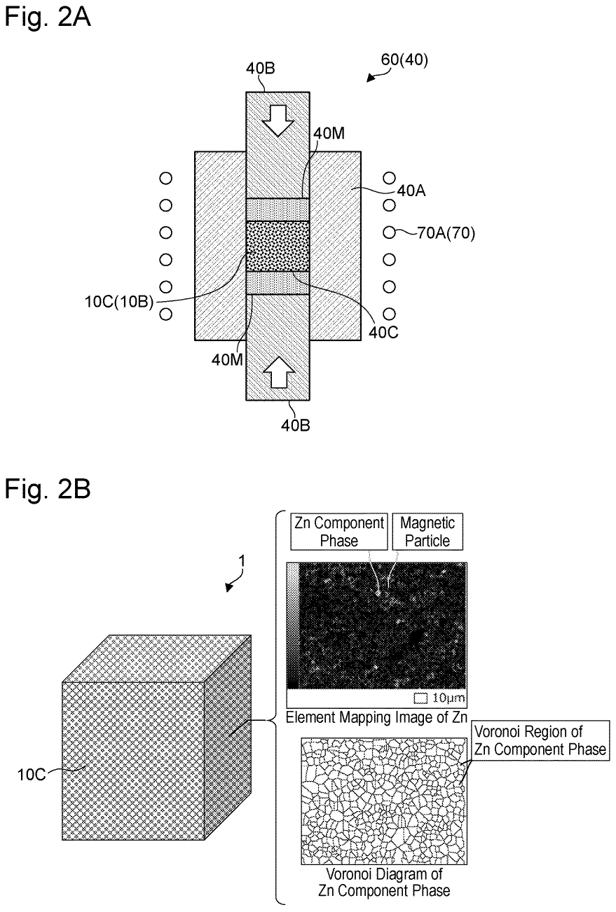

First, an outline of a rare earth magnet according to an embodiment and a method for producing the rare earth magnet will be described by exemplifying a rare earth magnet according to a first embodiment and a method for producing the rare earth magnet. FIG. 1A to FIG. 2B are schematic process drawings illustrating the method for producing the rare earth magnet according to the first embodiment.

In the method for producing the rare earth magnet according to the first embodiment, first, as illustrated in FIG. 1A, a magnetic powder with combined particle sizes 6 (SmFeN-based magnetic powder) containing a first coated magnetic powder 3 that has a large particle size and a second coated magnetic powder 5 that has a small particle size is prepared (magnetic powder preparation step). The first coated magnetic powder 3 includes coated magnetic particles 2 containing magnetic particles 2a and phosphate coatings 2b covering the surfaces of the magnetic particles 2a. The second coated magnetic powder 5 includes coated magnetic particles 4 containing magnetic particles 4a and phosphate coatings 4b covering the surfaces of the magnetic particles 4a. The first coated magnetic powder 3 and the second coated magnetic powder 5 are SmFeN-based anisotropic magnetic powders.

Next, as illustrated in FIG. 1B, a zinc powder 8 (metallic zinc powder) containing scale-shaped zinc particles 7 (metallic zinc particles) is prepared (zinc powder preparation step).

Next, as illustrated in FIG. 1C, the magnetic powder with combined particle sizes 6 containing the first coated magnetic powder 3 and the second coated magnetic powder 5 and the zinc powder 8 are combined, and are dispersed and mixed with a medium of a resin-coated metal or ceramic using a vibrating mill (not illustrated), thereby obtaining a mixed powder 10A (mixing step).

Next, as illustrated in FIG. 1D, using a molding die 40 and a pair of electromagnetic coils 50, the mixed powder 10A is subjected to compression molding in a magnetic field (magnetic field molding) to obtain a magnetic field molded body 10B (magnetic field molding step). The molding die 40 includes a die 40A, a pair of punches 40B, and a pair of permanent magnets 40M. The die 40A has a cavity 40C, and the pair of punches 40B slide inside the cavity 40C. The pair of electromagnetic coils 50 are arranged on both sides of the die 40A in a sliding direction (open arrow direction) of the pair of punches 40B. Magnetic field molding is performed in a nitrogen gas atmosphere. At this time, as illustrated in FIG. 1D, the mixed powder 10A is stored within the cavity 40C of the die 40A with the mixed powder 10A interposed between the pair of permanent magnets 40M (for example, SmCo-based magnets) from both sides in the sliding direction. With a stacked body of the pair of permanent magnets 40M and the mixed powder 10A being interposed between the pair of punches 40B from both the sides in the sliding direction, the pair of punches 40B are slid toward a side of the mixed powder to perform compression molding on the mixed powder 10A until a predetermined density is obtained, and at the same time, the electromagnetic coils 50 apply a pulsed magnetic field in the sliding direction (arrow direction) of the pair of punches 40B to the mixed powder 10A. Such magnetic field orientation in the magnetic field molding aligns magnetization easy axes of the magnetic particles of the magnetic field molded body 10B.

Next, as illustrated in FIG. 2A, using a sintering die 60 and a heater 70, the magnetic field molded body 10B is pressure-sintered to obtain a sintered body 10C (pressure sintering step). For the sintering die 60, the molding die 40 is used as it is. The heater 70 includes a high-frequency induction coil 70A. Pressure sintering is performed in an argon gas atmosphere. At this time, the high-frequency induction coil 70A of the heater 70 are arranged around the die 40A in a direction perpendicular to the sliding direction (open arrow direction) of the pair of punches 40B of the sintering die 60. Subsequently, while the high-frequency induction coil 70A are heating the magnetic field molded body 10B in the cavity 40C of the die 40A, the pair of punches 40B are further slid to the magnetic field molded body side to press the magnetic field molded body 10B. The magnetic field molded body is thus pressure-sintered at a predetermined sintering temperature and at a predetermined pressurizing pressure for a predetermined pressurization time.

Next, the sintered body 10C is taken out from the inside of the cavity 40C. Thus, as illustrated in FIG. 2B, as the rare earth magnet according to the first embodiment, a rare earth magnet 1 including the sintered body 10C is produced.

In the sintered body of the rare earth magnet according to the first embodiment, as shown in the element mapping image of zinc on the cross-sectional surface of the sintered body in FIG. 2B, the magnetic particles in the magnetic powder with combined particle sizes are bonded by a zinc component phase. The zinc component phase is considered to be a phase containing the zinc components derived from the zinc particles, and is considered to be a phase containing the modified phase in which a-Fe phases of the surface portions of the magnetic particles and the zinc components in the zinc particles are alloyed. A Voronoi diagram is obtained by Voronoi tessellation using the centers of gravity of the zinc component phases as seeds (sites or generators) on the cross-sectional surface of the sintered body. A standard deviation of areas of Voronoi regions in the Voronoi diagram is 65 μm² or less. That is, the zinc component phases are well dispersed and arranged between the magnetic particles in the sintered body. Accordingly, in the process of forming the sintered body by pressure-sintering the magnetic field molded body of the mixed powder, the zinc component phase effectively provides an effect of improving the fluidity of the magnetic particles. This densifies the sintered body even without increasing the pressurizing pressure in the pressure sintering. Accordingly, the densification of the sintered body is achieved while suppressing the accumulation of the strain in the magnetic phase of the sintered body in accordance with the increase of the pressurizing pressure in the pressure sintering, and thus, the residual magnetization Br of the rare earth magnet is improvable.

In the method for producing the rare earth magnet according to the first embodiment, the magnetic powder with combined particle sizes containing the first coated magnetic powder with a large particle size and the second coated magnetic powder with a small particle size is prepared as the magnetic powder, the zinc powder containing the scale-shaped zinc particles is prepared as the zinc powder, and the magnetic powder with combined particle sizes and the zinc powder are combined, and dispersed and mixed with a medium using the vibrating mill, and thus, the mixed powder is obtained. Therefore, in the process of forming the sintered body by pressure-sintering the magnetic field molded body of the mixed powder, the zinc component phases derived from the zinc particles are well dispersed and arranged between the magnetic particles, and thus, the zinc component phases derived from the zinc particles can effectively provide an effect of improving the fluidity of the magnetic particles. Subsequently, the rare earth magnet according to the embodiment and the method for producing the rare earth magnet will be described in detail.

### 1. Rare Earth Magnet

The rare earth magnet according to the embodiment includes the sintered body of the mixed powder having (comprising) the magnetic powder containing the magnetic particles containing Sm, Fe, and N (hereinafter sometimes abbreviated as “SmFeN-based magnetic powder”) and the zinc powder containing the zinc particles containing at least one of a metallic zinc or a zinc alloy, wherein the standard deviation of the areas of the Voronoi regions in the Voronoi diagram obtained by Voronoi tessellation using the center of gravity of the zinc component phase as the seed (site or generator) on the cross-sectional surface of the above-described sintered body is 65 μm² or less.

While the sintered body of the rare earth magnet is not specifically limited as long as the above-described standard deviation is 65 μm² or less, for example, the above-described standard deviation is 63 μm² or less in some embodiments. This is because the sintered body is more densified. The sintered body of the rare earth magnet has a mean value of the areas of the Voronoi regions in the above-described Voronoi diagram of, for example, 106 μm² or less, and among them, the mean value may be 103 μm² or less. The sintered body of the rare earth magnet has a ratio (standard deviation/mean value) of the standard deviation and the mean value of the areas of the Voronoi regions in the above-described Voronoi diagram of, for example, 0.613 or less, and among them, the ratio (standard deviation/mean value) may be 0.610 or less.

The SmFeN-based magnetic powder used in the mixed powder from which the sintered body of the rare earth magnet is obtained is similar to the SmFeN-based magnetic powder described in “2. Method For Producing Rare Earth Magnet” described later. The zinc powder used in the mixed powder is similar to the zinc powder described in “2. Method For Producing Rare Earth Magnet.” The mixed powder is similar to the mixed powder described in “2. Method For Producing Rare Earth Magnet.” The sintered body of the rare earth magnet may be a sintered body of the magnetic field molded body of the mixed powder. The rare earth magnet may be produced in the method for producing the rare earth magnet according to the embodiment described in “2. Method For Producing Rare Earth Magnet”.

### 2. Method for Producing Rare Earth Magnet

The method for producing the rare earth magnet according to the embodiment includes a magnetic powder preparation step, a zinc powder preparation step, a mixing step, a magnetic field molding step, and a pressure sintering step.

### (1) Magnetic Powder Preparation Step

In the magnetic powder preparation step, a magnetic powder containing magnetic particles containing Sm, Fe, and N (hereinafter sometimes abbreviated as “SmFeN-based magnetic powder”) is prepared. The SmFeN-based magnetic powder is not particularly limited as long as the magnetic powder contains magnetic particles having (comprising) a magnetic phase containing Sm, Fe, and N. The SmFeN-based magnetic powder may be a common magnetic powder, and may, for example, be an anisotropic magnetic powder (hereinafter sometimes abbreviated as “SmFeN-based anisotropic magnetic powder”). The SmFeN-based magnetic powder may be, for example, an uncoated magnetic powder in which the surface of the magnetic particle is not covered with a phosphate coating (phosphoric acid coating), or may be a coated magnetic powder containing coated magnetic particles including magnetic particles and phosphate coatings covering the surfaces of the magnetic particles. The SmFeN-based magnetic powder is a coated magnetic powder in some embodiments. This is because the phosphate coating can suppress deterioration of the magnetic particles due to oxidation in the producing process of the magnet.

The coated magnetic powder is obtained by treating an uncoated magnetic powder with phosphoric acid. The method of the phosphoric acid treatment is not particularly limited, and may be a common method. The phosphate coating has a film thickness not particularly limited, and may be a common film thickness, but the film thickness is, for example, 1 nm or more and 50 nm or less, and among them, the film thickness may be 5 nm or more and 30 nm or less.

An average particle size of the magnetic powder herein means a cumulative 50% particle size D₅₀ in the volume-based particle size distribution measured with a laser diffraction particle size distribution analyzer or the like. The average particle size (D₅₀) of the SmFeN-based magnetic powder is not particularly limited, and may be a common one, but, for example, may be 2 μm or more and 5 μm or less, and among them, may be 2.5 μm or more and 4.5 μm or less. When the average particle size of the magnetic powder is too small, the filling amount of the magnetic powder in the magnet may be small, decreasing the magnetization. On the other hand, when the average particle size of the magnetic powder is too large, the coercive force of the magnet tends to decrease.

The SmFeN-based magnetic powder is not particularly limited but may be a magnetic powder with combined particle sizes containing the first magnetic powder with a large particle size and the second magnetic powder with a small particle size, or may be a magnetic powder containing only a magnetic powder with a single particle size distribution, but is the magnetic powder with combined particle sizes containing the first magnetic powder with a large particle size and the second magnetic powder with a small particle size in some embodiment. This is because the sintered body is easily densified. The content of the second magnetic powder with respect to the magnetic powder with combined particle sizes is, for example, 5 mass % (mass percent) or more and 30 mass % or less, and among them, may be 7.5 mass % or more and 20 mass % or less, and in particular, may be 10 mass % or more and 15 mass % or less. This is because the sintered body is particularly easily densified. The first magnetic powder may be an uncoated magnetic powder (first uncoated magnetic powder), or may be a coated magnetic powder (first coated magnetic powder). The second magnetic powder may be an uncoated magnetic powder (second uncoated magnetic powder), or may be a coated magnetic powder (second coated magnetic powder). The average particle size (D₅₀) of the first magnetic powder is not particularly limited, and may be a common one, but, for example, from the aspect of densifying the sintered body, may be 2.5 μm or more and 4.5 μm or less, and among them, may be 2.6 μm or more and 3.6 μm or less. The average particle size (D₅₀) of the second magnetic powder is not particularly limited, and may be a common one, but, for example, from the aspect of densifying the sintered body, may be 1.0 μm or more and 2.0 μm or less, and among them, may be 1.3 μm or more and 1.9 μm or less.

The magnetic phase of the magnetic particles of the SmFeN-based magnetic powder is not particularly limited, and may be a common one, but is a phase at least partially having (comprising) a crystalline structure of at least one of Th₂Zn₁₇ type and Th₂Ni₁₇ type. The magnetic phase is not particularly limited, and the examples of the magnetic phase further include a phase having (comprising) a TbCu₇ type crystalline structure or the like. Note that Sm is samarium, Fe is iron, and N is nitrogen. Th is thorium, Zn is zinc, Ni is nickel, Tb is terbium, and Cu is copper.

The magnetic particles in the SmFeN-based magnetic powder are not particularly limited as long as the magnetic particles have the magnetic phase as described above, and may have a general composition. Examples of the magnetic particles include particles further containing one or more elements selected from a group consisting of La (lanthanum), W (tungsten), and R (R is at least one selected from a group consisting of Ti (titanium), Ba (barium), Sr (strontium), and Co (cobalt)), in addition to Sm, Fe, and N, and among them, particles in which the composition of the magnetic particles is represented by the following general formula (1) are used in some embodiments.

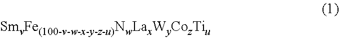

(in the formula, the conditions of 3≤v≤30, 5≤w≤15, 0≤x≤0.3, 0≤y≤2.5, 0≤z≤2.5, and 0≤u≤2.5 are satisfied.)

When the magnetic particles of the SmFeN-based magnetic powder further contain La, the content of La, for example, in terms of residual magnetization Br, may be 0.1 mass % or more and 5 mass % or less, and among them, may be 0.15 mass % or more and 1 mass % or less. When the magnetic particles of the SmFeN-based magnetic powder further contain W, the content of W, for example, in terms of coercive force, may be 0.1 mass % or more and 5 mass % or less, and among them, may be 0.15 mass % or more and 1 mass % or less. When the magnetic particles of the SmFeN-based magnetic powder further contain Co, the content of Co, for example, in terms of temperature properties, may be 0.1 mass % or more and 5 mass % or less, and among them, may be 0.15 mass % or more and 1 mass % or less. When the magnetic particles of the SmFeN-based magnetic powder further contain Ti, the content of Ti, for example, in terms of temperature properties, may be 0.1 mass % or more and 5 mass % or less, and among them, may be 0.15 mass % or more and 1 mass % or less.

### (2) Zinc Powder Preparation Step

In the zinc powder preparation step, a zinc powder containing zinc particles containing at least one of a metallic zinc or a zinc alloy is prepared. The zinc powder is a modifier powder that modifies and bonds the magnetic particles of the magnetic powder by the zinc component.

While the zinc powder is not particularly limited, and may be a zinc powder generally used as a modifier powder, for example, a metallic zinc powder containing metallic zinc particles containing a metallic zinc as the zinc particles may be used as the zinc powder, or a zinc alloy powder containing zinc alloy particles containing a zinc alloy as the zinc particles may be used as the zinc powder.

The zinc particles of the zinc powder may be scale-shaped zinc particles. This is because the effect of improving the fluidity of the magnetic particles in the pressure sintering can be effectively provided. The mean value of the film thickness of the zinc powder containing the scale-shaped zinc particles, for example, from the aspect of improving the fluidity of the magnetic particles, may be 0.01 μm or more and 2 μm or less, and among them, may be 0.02 μm or more and 1.0 μm or less. The mean value of equivalent circle diameters in an in-plane direction (direction perpendicular to a film thickness direction) of the zinc powder containing the scale-shaped zinc particles, for example, from the aspect of improving the fluidity of the magnetic particles, may be 1 μm or more and 50 μm or less, and among them, may be 3 μm or more and 40 μm or less. Herein, the mean value of the equivalent circle diameters in the in-plane direction of the zinc powder means a mean value of diameters of circumscribed circles (maximum circles) of the zinc particles when viewing the zinc particles contained in the zinc powder in plan view. The mean value of the film thicknesses and the mean value of the equivalent circle diameters in the in-plane direction of the zinc powder containing the scale-shaped zinc particles can be measured as a mean value of the measurement values of at least 10 or more scale-shaped zinc particles from a SEM image photographing the zinc powder with a scanning electron microscope (SEM). Note that the aspect ratio of the zinc powder may be, for example, 1.01 or more and 3.00 or less, and among them, may be 1.02 or more and 2.80 or less. Herein the aspect ratio of the zinc powder means a mean value of ratios of diameter in long axis direction to diameter in short axis direction (diameter in long axis direction/diameter in short axis direction) of the zinc particles when viewing the zinc particles contained in the zinc powder in plan view.

### (3) Mixing Step

In the mixing step, a mixed powder is obtained by mixing the magnetic powder and the zinc powder. The mixing method of the magnetic powder and the zinc powder is not particularly limited, and may be a common method. Examples of the mixing method include a method using a vibrating mill, a ball mill, a mortar, and the like.

The content of the zinc powder with respect to the mixed powder is not particularly limited and may be a common content. In terms of residual magnetization, for example, the content may be 2 mass % or more and 25 mass % or less with respect to the mixed powder, among them, may be 5 mass % or more and 10 mass % or less with respect to the mixed powder, and in particular, may be 7.5 mass % or more and less than 10 mass % with respect to the mixed powder. This is because the effect of improving the fluidity of the magnetic particles in the pressure sintering can be effectively provided.

The mixing step is not particularly limited, but may be a step of combining the magnetic powder and the zinc powder, dispersing and mixing the mixture of the magnetic powder and the zinc powder with a medium of the resin-coated metal or ceramic using a vibrating mill, and thus obtaining the mixed powder. Examples of conditions of such a step include a condition in which the magnetic powder with combined particle sizes and the zinc powder, and the medium are put in the container of the vibrating mill such that the magnetic powder with combined particle sizes and the zinc powder are together, for example, 1 volume % or more and 20 volume % or less, and the medium is, for example, 5 volume % or more and 50 volume % or less with respect to the volume of the container of the vibrating mill, and the magnetic powder with combined particle sizes and the zinc powder are dispersed in an inert atmosphere, such as a nitrogen atmosphere.

### (4) Magnetic Field Molding Step

In the magnetic field molding step, a magnetic field molded body is obtained by performing compression molding on the mixed powder in a magnetic field (hereinafter, sometimes abbreviated as “magnetic field molding”). An orientation is imparted to the magnetic field molded body. This imparts anisotropy to the rare earth magnet and improves the residual magnetization Br.

The method of magnetic field molding is not particularly limited and a common method may be used. Examples of the method include a method such as performing compression molding on the mixed powder in a molding die while applying a magnetic field to the mixed powder with a magnetic field generator disposed around the molding die such as a metallic mold. Examples of the magnetic field generator include a device that applies a pulsed magnetic field and the like. The atmosphere in which the magnetic field molding is performed is not particularly limited, and may be, for example, an inert gas atmosphere, such as an argon gas atmosphere and a nitrogen gas atmosphere. This is because the inert gas atmosphere can suppress oxidation of the magnetic field molded body. The conditions of the magnetic field molding may be the conditions in which, for example, when the pulsed magnetic field is applied in one round trip (back and forth once), the molding pressure of the magnetic field molding is 5 MPa or more and 1000 MPa or less, the application period of the molding pressure is 1 minute or more and 5 minutes or less, and the magnitude of the pulsed magnetic field is 1 T or more and 8 T or less. This is because the densification of the sintered body of the rare earth magnet and the suppression of the strain in the magnetic phase can be obtained at the same time.

### (5) Pressure Sintering Step

In the pressure sintering step, a sintered body is obtained by performing pressure sintering on the magnetic field molded body (hereinafter, sometimes abbreviated as “pressure sintering”). The method of pressure sintering is not particularly limited and a common method may be used. Examples of the method include a method such as heating a magnetic field molded body with a heating device while pressing the magnetic field molded body with a molding die such as a metallic mold. Examples of the heating device include a heater including a high-frequency induction coil arranged on the periphery of the molding die, or the like. The atmosphere in which the pressure sintering is performed is not particularly limited, and may be, for example, an inert gas atmosphere, such as an argon gas atmosphere and a nitrogen gas atmosphere. This is because the inert gas atmosphere can suppress oxidation of the sintered body. The condition of the pressure sintering may be, for example, condition in which the sintering temperature is 350° C. or more and 500° C. or less, the pressurizing pressure is 500 MPa or more and 2000 MPa or less, and the pressure sintering period is 1 minute or more and 60 minutes or less. This is because the densification of the sintered body of the rare earth magnet and the suppression of the strain in the magnetic phase can be obtained at the same time.

### EXAMPLES

The following further specifically describes the rare earth magnet according to the embodiment and the method for producing the rare earth magnet with Examples and Comparative Examples.

### Example 1

An example of the method for producing the rare earth magnet according to the above-described first embodiment was performed.

In the method for producing the rare earth magnet in Example 1, first, as illustrated in FIG. 1A, the first coated magnetic powder 3 with a large particle size (average particle size (D₅₀)=3.1 μm) and the second coated magnetic powder 5 with a small particle size (average particle size (D₅₀)=1.4 μm) were mixed at a mass ratio of the first coated magnetic powder:the second coated magnetic powder=87 mass %: 13 mass %, thus, the magnetic powder with combined particle sizes 6 (SmFeN-based anisotropic magnetic powder) was prepared (magnetic powder preparation step). Note that the first coated magnetic powder and the second coated magnetic powder are the respective coated magnetic powders containing the coated magnetic particles that include the magnetic particles having (comprising) a magnetic phase containing Sm, Fe, and N, and the phosphate coatings covering the surfaces of the magnetic particles. The first coated magnetic powder and the second coated magnetic powder were both obtained by forming the phosphate coatings in the conditions in which an uncoated magnetic powder was added in pure water, a phosphoric acid solution was further added thereto, and the mixture was stirred and subjected to solid-liquid separation, and thereafter was vacuum dried. The magnetic particles of the first coated magnetic powder and the second coated magnetic powder contain Sm, Fe, N, and La.

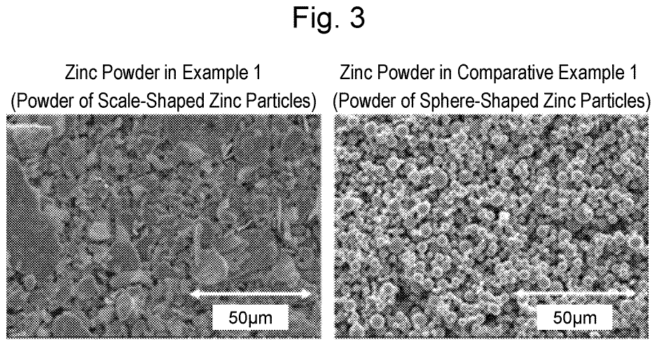

Next, as illustrated in FIG. 1B, the zinc powder 8 (metallic zinc powder) containing the scale-shaped zinc particles 7 (metallic zinc particles) was prepared (zinc powder preparation step). The zinc powder is a metallic zinc powder having (comprising) a purity of the zinc component in the metal constituent of 98 mass %, an oxygen content of 2 mass %, a mean value of film thicknesses of 0.3 μm, and a mean value of equivalent circle diameters in the in-plane direction of 15 μm. The zinc powder has an aspect ratio of 1.55. The zinc powder in Example 1 was photographed with a scanning electron microscope (SEM). The SEM image of the zinc powder in Example 1 is shown on the left side in FIG. 3.

Next as illustrated in FIG. 1C, the magnetic powder with combined particle sizes 6 containing the first coated magnetic powder 3 and the second coated magnetic powder 5, and the zinc powder 8 were combined such that the content of the zinc powder with respect to the mixed powder was 10.0 mass %, and were dispersed and mixed with a medium of a resin-coated metal using a vibrating mill (not illustrated), thus, the mixed powder 10A was obtained (mixing step). At this time, first, the magnetic powder with combined particle sizes and the zinc powder, and the medium were put in the container of the vibrating mill such that the magnetic powder with combined particle sizes and the zinc powder were together 3 volume %, and the medium (iron core nylon medium, diameter 12 mm, specific gravity 8, nylon layer thickness approximately 1 mm to 3 mm) was 20 volume % with respect to the volume of the container of the vibrating mill. Subsequently, the vibrating mill dispersed the mixture in the nitrogen atmosphere for 30 minutes, and the mixed powder was obtained. Note that the obtained mixed powder was packed together with paraffin wax in a sample container, the paraffin wax was melted with a drier, and thereafter, the magnetization easy axes were aligned by orientation magnetic field of 16 kA/m. This sample oriented in the magnetic field was pulse magnetized in a magnetizing magnetic field of 3200 kA/m, and a residual magnetization or [emu/g], a coercive force iHc [Oe], and a squareness ratio Hk [Oe] were measured using a VSM (vibrating sample magnetometer) having (comprising) a maximum magnetic field of 16000 kA/m. The features of the mixed powder in Example 1 is shown in Table 1 below.

Next, as illustrated in FIG. 1D, the mixed powder 10A was compressed and molded in a magnetic field (magnetic field molding) using the molding die 40 and the pair of electromagnetic coils 50, and thus, the magnetic field molded body 10B was obtained (magnetic field molding step). The magnetic field molding was performed in the nitrogen gas atmosphere. At this time, as illustrated in FIG. 1D, 1.5 g of the mixed powder was stored in the cavity 40C of the die 40A with 1.5 g of the mixed powder being sandwiched between the pair of permanent magnets 40M (SmCo-based magnet) from both sides in the sliding direction. The pair of punches 40B were slid to the mixed powder side with the stacked body of the pair of permanent magnets 40M and the mixed powder 10A being sandwiched between the pair of punches 40B from both sides in the sliding direction, and thus, the mixed powder 10A was compressed and molded (molding pressure: 200 MPa, molding pressure application period: 1 minute) until the density of 5 g/cm³ was obtained, and at the same time, the electromagnetic coils 50 applied a pulsed magnetic field (6 T) on the mixed powder 10A in one round trip (back and forth once) in the sliding direction of the pair of punches 40B. Such magnetic field orientation in the magnetic field molding aligned the magnetization easy axes of the magnetic particles of the magnetic field molded body 10B.

Next, as illustrated in FIG. 2A, the magnetic field molded body 10B was pressure-sintered using the sintering die 60 and the heater 70, and thus, the sintered body 10C was obtained (pressure sintering step). The pressure sintering was performed in the argon gas atmosphere of 97000 Pa. At this time, the high-frequency induction coil 70A of the heater 70 were arranged on the periphery of the die 40A in the direction perpendicular to the sliding direction (open arrow direction) of the pair of punches 40B of the sintering die 60. While heating the magnetic field molded body 10B in the cavity 40C of the die 40A with the high-frequency induction coil 70A, the pair of punches 40B were further slid to the magnetic field molded body side, and thus, the magnetic field molded body 10B was pressurized. The sintering temperature was 420° C., the pressurizing pressure was 750 MPa, and the pressure sintering period was 5 minutes.

Next, the sintered body 10C was taken out from the inside of the cavity 40C. Thus, the rare earth magnet 1 including the sintered body 10C was produced as illustrated in FIG. 2B.

### Example 2

A rare earth magnet was produced by a production method similar to that in Example 1 except that the magnetic powder with combined particle sizes and the zinc powder were combined such that the content of the zinc powder with respect to the mixed powder was 7.5 mass % when the mixed powder was obtained in the mixing step. The features of the mixed powder in Example 2 are shown in Table 1 below.

### Comparative Example 1

A rare earth magnet was produced by a production method similar to that in Example 1 except that a zinc powder (metallic zinc powder) containing sphere-shaped zinc particles (metallic zinc particles) was prepared in the zinc powder preparation step, and the zinc powder was combined with the magnetic powder with combined particle sizes when the mixed powder was obtained in the mixing step. The metallic zinc powder had a purity of a zinc component in the metal constituent of the zinc powder of 99 mass %, the content of the oxygen in the zinc powder of 1 mass %, an average particle size (D₅₀) of the zinc powder of 4.4 μm. Note that the zinc powder in Comparative Example 1 was photographed with a scanning electron microscope (SEM). FIG. 3 illustrates a SEM image of the zinc powder in Comparative Example 1. The features of the mixed powder in Comparative Example 1 are shown in Table 1 below.

### Comparative Example 2

A rare earth magnet was produced by a production method similar to that in Comparative Example 1 except that the magnetic powder with combined particle sizes and the zinc powder were combined such that the content of the zinc powder with respect to the mixed powder was 15.0 mass % when the mixed powder was obtained in the mixing step. The features of the mixed powder in Comparative Example 2 are shown in Table 1 below.

TABLE 1

| | Mixed Powder | | | | | | |
|---|---|---|---|---|---|---|---|
| | Magnetic Powder With | | | | | | |
| | Combined Particle Size | | | | | | |
| | First | Second | | | | | |
| | Coated | Coated | | Zinc Powder | | | |
| | Magnetic | Magnetic | | | Zinc | | |
| | Powder | Powder | | | Component | | film |
| | Average | Average | | | Purity | | Thickness |
| | Particle | Particle | Mixing | Zinc | in Metal | Oxygen | Mean |
| | Size | Size | Ratio | Particle | Constituent | Content | Value |
| No. | [μm] | [μm] | (*1) | Shape | [mass %] | [mass %] | [μm] |
| Example 1 | 3.1 | 1.4 | 87:13 | Scale | 98 | 2 | 0.3 |
| | | | | Shape | | | |
| Example 2 | 3.1 | 1.4 | 87:13 | Scale | 98 | 2 | 0.3 |
| | | | | Shape | | | |
| Comparative | 3.1 | 1.4 | 87:13 | Sphere | 99 | 1 | — |
| Example 1 | | | | Shape | | | |
| Comparative | 3.1 | 1.4 | 87:13 | Sphere | 99 | 1 | — |
| Example 2 | | | | Shape | | | |

| | Mixed Powder | | | | | | |
|---|---|---|---|---|---|---|---|
| | Zinc Powder | | | | | | |
| | In-Plane | | | | | | |
| | Direction | | | | | | |
| | Equivalent | | | | | | |
| | Circle | | Average | Zinc | | | |
| | Diameter | Aspect | Particle | Powder | Magnetic Properties | | |
| | Mean Value | Ratio | Size | Content | σr | iHc | Hk |
| No. | [μm] | [—] | [μm] | [Mass %] | [emu/g] | [Oe] | [Oe] |
| Example 1 | 15 | 1.55 | — | 10.0 | 138.4 | 10380 | 5009 |
| Example 2 | 15 | 1.55 | — | 7.5 | 140.1 | 10280 | 5001 |
| Comparative | — | — | 4.4 | 10.0 | 140.3 | 10580 | 5815 |
| Example 1 | | | | | | | |
| Comparative | — | — | 4.4 | 15.0 | 135.3 | 10680 | 5875 |
| Example 2 | | | | | | | |

*1 Mass Ratio of First Coated Magnetic Powder to Second Coated Magnetic Powder (Mass of First Coated Magnetic Powder:Mass of Second Coated Magnetic Powder)

### [Evaluation Of Density]

A weight and dimensions of the sintered body of the rare earth magnet in each of Examples 1 to 2 and Comparative Examples 1 to 2 were measured. A bulk density [g/cm³] of the sintered body was then calculated from the weight and volume (calculated from the dimensions) of the sintered body of the rare earth magnet. The results are shown in Table 2 below.

### [Evaluation of Magnetic Properties]

The magnetic properties of the rare earth magnet in each of Examples 1 to 2 and Comparative Examples 1 to 2 were evaluated. At this time, at room temperature, the rare earth magnet of each example was pulse magnetized in a magnetizing magnetic field of 6400 kA/m and a residual magnetization Br [T] was measured using a VSM (vibrating sample magnetometer) having (comprising) a maximum magnetic field of 1600 kA/m. The results are shown in Table 2 below.

[Evaluation of Voronoi Regions Using Centers of Gravity of Zinc Component Phase as Seeds (sites or generators) on Cross-Sectional Surface of Sintered Body]

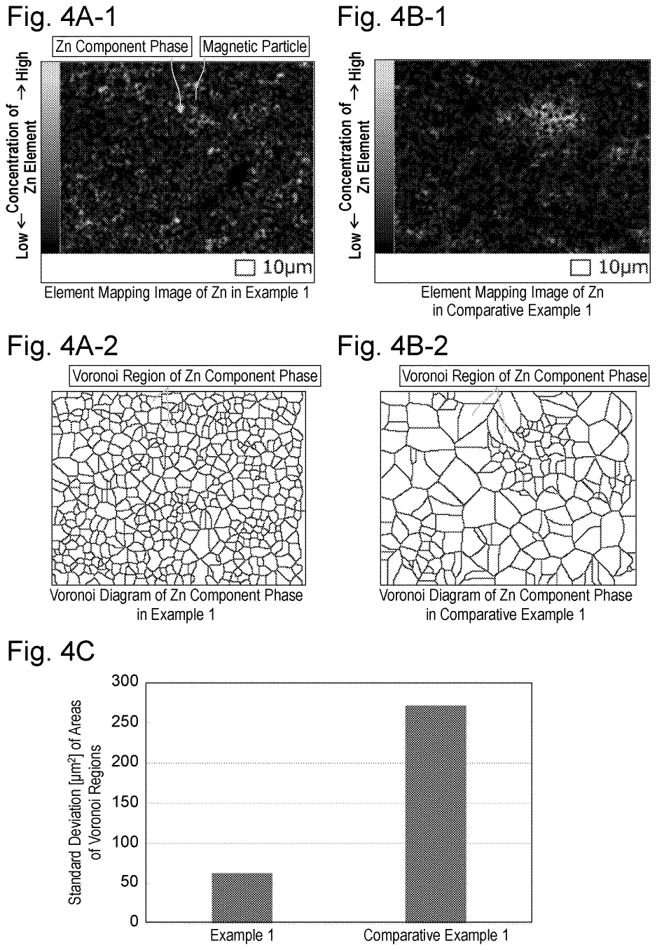

A standard deviation [μm²] of areas of Voronoi regions in a Voronoi diagram obtained by Voronoi tessellation using the centers of gravity of zinc component phases as seeds (sites or generators) on a cross-sectional surface of the sintered body of the rare earth magnet in each of Examples 1 to 2 and Comparative Examples 1 to 2 and a mean value [μm²] of the areas of the Voronoi regions, and their ratio (standard deviation/mean value) were obtained. At this time, first, the cross-sectional surface of the sintered body of the rare earth magnet was photographed at 3000× observation magnification using a scanning electron microscope (SEM, made by JEOL Ltd., JSM-IT500) to obtain a backscattered electron image, and elemental analysis was performed on the imaged area of the backscattered electron image at 3000× visual field using an energy-dispersive X-ray spectrometer with a SEM (SEM-EDX), and a count was accumulated for 10 minutes, thereby obtaining a zinc element mapping image in which, for each pixel, the display color changes from black to brighter green as the zinc concentration increases. Next, binarization by Otsu's method was performed on the element mapping image of zinc using image analysis software (ImageJ Fiji), and thus, a bright region and a dark region were divided, and the bright region was the region of the zinc component phase. Next, Voronoi tessellation was performed on the element mapping image after the binarization using the centers of gravity of the zinc component phases as seeds (sites or generators) by means of image analysis software (ImageJ Fiji), and thus, a Voronoi diagram was obtained. Next, a standard deviation [μm²] of the areas of the Voronoi regions in the Voronoi diagram and a mean value [μm²] of the areas of the Voronoi regions were calculated as indicators to indicate a dispersion degree of the zinc component phases. Furthermore, their ratio (standard deviation/mean value) was calculated. The results are shown in Table 2 below. FIGS. 4A-1 and 4B-1 are respective element mapping images of zinc on the cross-sectional surfaces of the sintered bodies of the rare earth magnets in Example 1 And Comparative Example 1. FIGS. 4A-2 and 4B-2 are respective Voronoi diagrams of the zinc component phases on the cross-sectional surfaces of the sintered bodies of the rare earth magnets in Example 1 and Comparative Example 1. In the Voronoi diagrams in FIGS. 4A-2 and 4B-2, each of the Voronoi regions includes one zinc component phase. The area of the Voronoi region decreases in a place where the zinc component phase is dense, and the area of the Voronoi region increases in a place where the zinc component phase is sparse. FIG. 4C is standard deviations [μm²] of the areas of the Voronoi regions in the Voronoi diagrams of the zinc component phases on the cross-sectional surfaces of the sintered bodies of the rare earth magnets in Example 1 and Comparative Example 1.

TABLE 2

| | Properties of Rare Earth Magnet | | | | |
|---|---|---|---|---|---|
| | | | Zinc Component Phase | Zinc Component Phase | |
| | | | of Zinc Particles | of Zinc Particles | |
| | | | on Cross-Sectional | on Cross-Sectional | |
| | Sintered | | Surface of | Surface of | |
| | Body | | Sintered Body | Sintered Body | Standard |
| | Bulk | | Standard Deviation | Mean Value of Areas | Deviation/ |
| | Density | Br | of Areas of | of Voronoi Regions | Mean Value |
| No. | [g/cm³] | [T] | Voronoi Regions [um²] | [um²] | [—] |
| Example 1 | 6.18 | 0.982 | 62.8 | 103.0 | 0.610 |
| Example 2 | 6.13 | 0.975 | 65.0 | 106.0 | 0.613 |
| Comparative Example 1 | 5.91 | 0.923 | 271.2 | 292.5 | 0.927 |
| Comparative Example 2 | 6.08 | 0.891 | 68.3 | 107.1 | 0.638 |

### [Discussion]

As shown in Tables 1 and 2 above and FIGS. 4A-1 to 4C, the rare earth magnets in Examples 1 and 2 have the scale-shaped zinc particles, which well disperses and arranges the zinc component phases in the sintered bodies, and therefore, the densities of the sintered bodies are improved, and in association with it, the residual magnetizations Br are also considered to be improved. The rare earth magnet in Comparative Example 1 has the sphere-shaped zinc particles compared with Examples 1 and 2, which fails to well disperse and arrange the zinc component phases in the sintered body, and therefore, the density of the sintered body is unimproved, and the residual magnetization Br is also considered unimproved. The rare earth magnet in Comparative Example 2 has the increased content of the zinc powder compared with Comparative Example 1, which improves the dispersion degree of the zinc component phases in the sintered body, but compared with Examples 1 and 2, the dispersion degree of the zinc component phases is low, and the content of the zinc powder, which is non-magnetic, is large, in Comparative Example 2, and therefore, the residual magnetization Br is considered to be low.

While the embodiments of the present disclosure have been described in detail above, the present disclosure is not limited thereto, and can be subjected to various kinds of changes in design without departing from the spirit of the present disclosure described in the claims.

All publications, patents and patent applications cited in the present description are herein incorporated by reference as they are.

### DESCRIPTION OF SYMBOLS

1 Rare earth magnet
2 Coated magnetic particle
2a Magnetic particle
2b Phosphate coating
3 First coated magnetic powder
4 Coated magnetic particle
4a Magnetic particle
4b Phosphate coating
5 Second coated magnetic powder
6 Magnetic powder with combined particle sizes (SmFeN-based magnetic powder)
7 Scale-shaped zinc particle
8 Zinc powder
10A Mixed powder
10B Magnetic field molded body
10C Sintered body

What is claimed is:

1. A rare earth magnet comprising
a sintered body of a mixed powder having (comprising) a magnetic powder containing magnetic particles containing Sm, Fe, and N, and a zinc powder containing zinc particles containing at least one of a metallic zinc or a zinc alloy,
wherein a standard deviation of areas of Voronoi regions in a Voronoi diagram obtained by Voronoi tessellation using centers of gravity of zinc component phases as seeds on a cross-sectional surface of the sintered body is 65 μm² or less.

2. The rare earth magnet according to claim 1,
wherein the zinc particles are scale-shaped zinc particles.
